(19) United States
(12) Patent Application Publication
(10) Pub. No.: US 2009/0178750 A1
(43) Pub. Date: Jul. 16, 2009

(54) MULTIPLE BEAD RADIAL TIRE

(76) Inventor: Maurice Taylor, Grosse Pointe Farms, MI (US)

Correspondence Address: DAVIS, BROWN, KOEHN, SHORS & ROBERTS, P.C.;THE DAVIS BROWN TOWER, 215 10TH STREET SUITE 1300, DES MOINES, IA, 50309, US

(21) Appl. No.: 12/354,711

(22) Filed: Jan. 15, 2009

Related U.S. Application Data
(60) Provisional application No. 61/021,328, filed on Jan. 15, 2008.

(51) Int. Cl. B60C 15/05; B60C 9/08

(52) U.S. Cl. 152/545

(57) ABSTRACT

A radial tire is provided for use with off-the-road (OTR) vehicles. The tire includes multiple beads, a nylon carcass and multiple nylon plies. The construction prevents slipping and rocking, and zipper-type failures. The tire also has improved lateral stability under load.

The present application claims priority to the application Ser. No. 61/021,328 filed Jan. 15, 2008, which is herein incorporated by reference in its entirety.

### BACKGROUND OF THE INVENTION

The invention relates generally to radial tires and, more specifically, to radial tires with multiple beads and a nylon carcass.

Off-the-Road tires (OTR) tires are used for construction vehicles such as wheel loaders, backhoes, graders, trenchers, and mining vehicles. OTR tires are typically radial tires, which use body ply cords extending from beads on opposite sides of the tire and across the tread so that the cords are laid at approximately right angles to the centerline of the tread, and parallel to each other.

Typically, OTR tires are steel-belted, singled ply, with one bead on each side of the tire. These tires are often required to sustain heavy loads, and may suffer from rocking and slipping, explosions, and sidewall zipper failures. Thus, a need exists for a OTR tire that is resistant to these problems.

### SUMMARY OF THE INVENTION

An object of the present invention is to provide a novel OTR tire.

A further object of the present invention is to provide a multiple bead radial tire.

Another object of the present invention is to provide a radial tire with multiple nylon body plies.

To that end, a multiple bead radial tire is provided. The tire is also constructed with multiple nylon body plies.

### BRIEF DESCRIPTION OF THE DRAWINGS

FIG. 1 shows a traditional single bead steel plied radial tire.

FIG. 2 shows the twin bead multi-plied radial tire of the present invention.

FIG. 3 shows the triple bead multi-plied radial tire of the present invention.

### DETAILED DESCRIPTION OF THE INVENTION

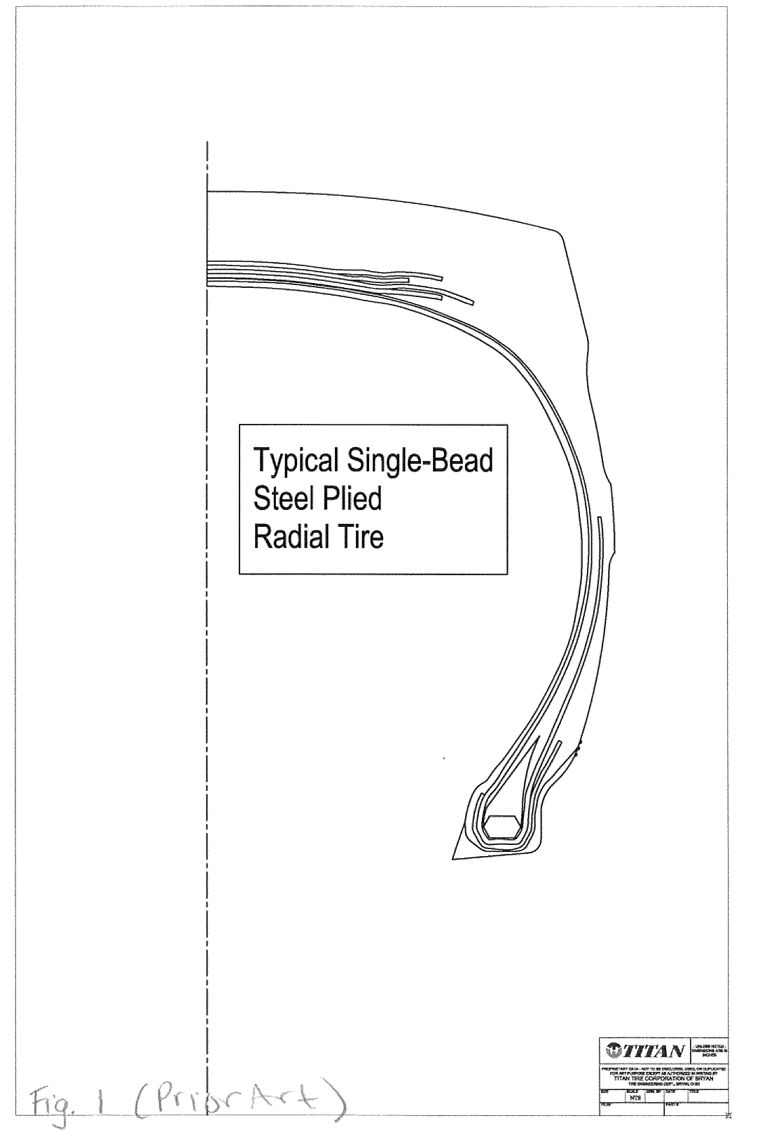

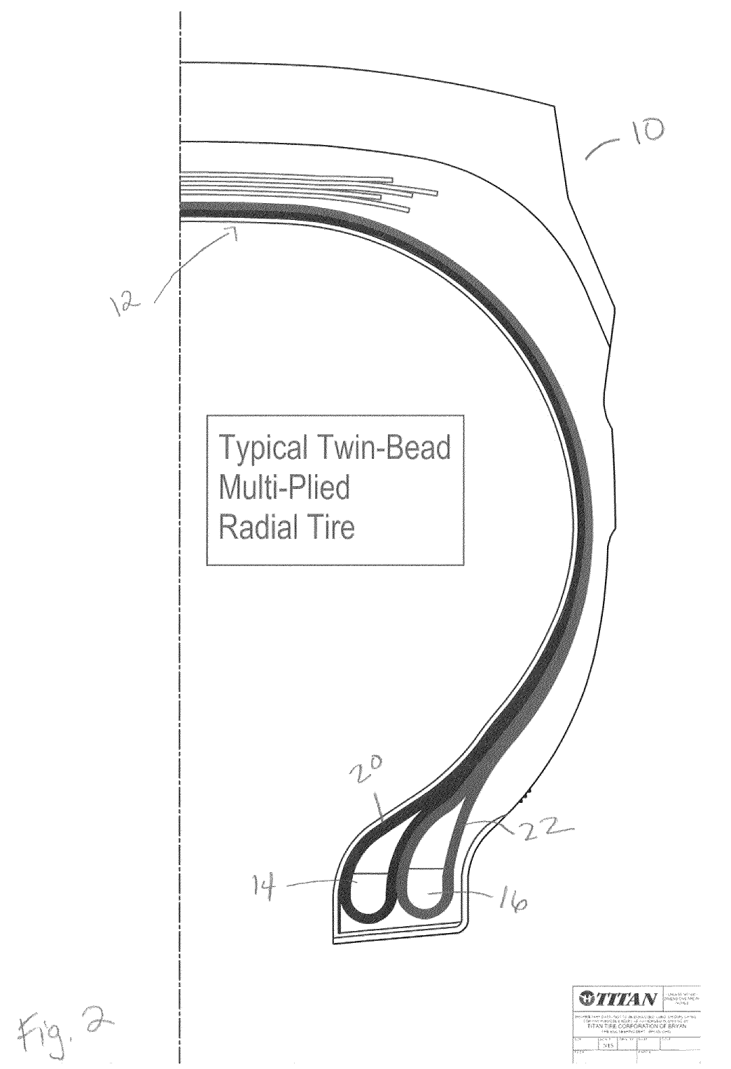

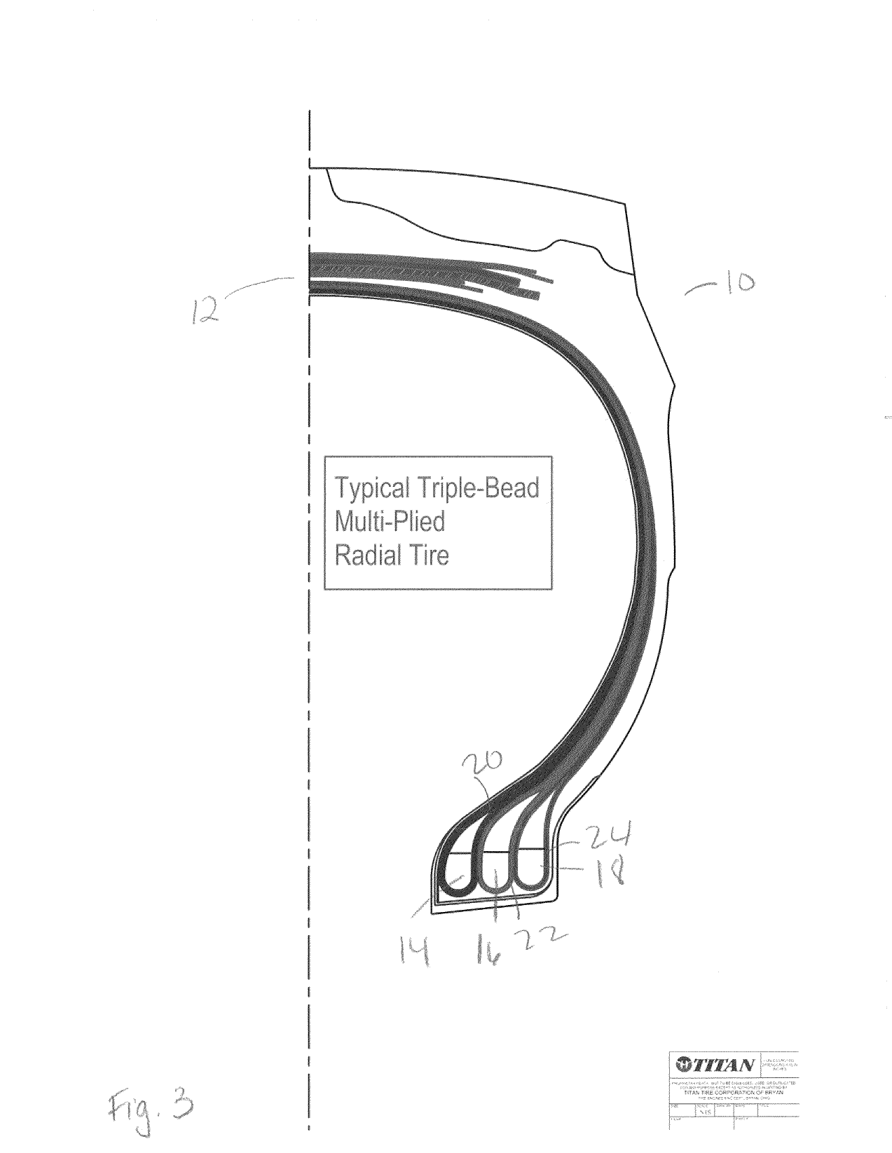

The prior art single bead steel plied radial tire is shown in FIG. 1. FIGS. 2-3 show the multi-bead, multi-plied radial tire 10 of the present invention. In one embodiment, the tire 10 is an off-the-road (OTR) radial tire. One specific use of these tires is in mining operations. The tire 10 includes a nylon carcass 12. The tire has at least two beads 14, 16, 18. Bead cores may be used. In the most typical example, the tire has two or three beads. The tire of the present invention may have four, five, six, or more beads. The tire 10 has multiple nylon body plies 20, 22, 24. In an alternate embodiment, the plies are not continuous.

There are several advantages to the multi-bead design and the nylon carcass. The multiple bead construction provides a larger contact area between the beads and wheel to prevent slipping and rocking, as compared to a single bead construction. The tire construction works with any bead taper angles from 0 degrees to 45 degrees. This construction allows for load and operational improvements due to the multiple beads being able to have uniform carrying ability, due to the nylon having a greater elongation ability over steel body plies. The multiple bead nylon tire has improved lateral stability under load compared to a standard steel body ply tire.

The multi-ply nylon carcass of the present invention has an improved sidewall resistance to cutting over a standard single ply steel carcass due to the thickness of the carcass of the present invention. The nylon carcass also runs cooler than steel body plies; the nylon carcass is not subject to heat generation caused by the steel body plies flexing.

The nylon carcass is safer than a steel body ply because nylon has greater elongation. In the event that the tire of the present invention is extremely overloaded, the tire will lose air and will not blow up like a steel tire. Nylon has greater elongation than steel which eliminates the potential for extreme loading of a single cord. In addition, the nylon carcass is safer than the steel body ply tire because there is no potential for zipper type failures, which are common for steel body ply tires.

The foregoing description and drawings comprise illustrative embodiments of the present inventions. The foregoing embodiments and the methods described herein may vary based on the ability, experience, and preference of those skilled in the art. Merely listing the steps of the method in a certain order does not constitute any limitation on the order of the steps of the method. The foregoing description and drawings merely explain and illustrate the invention, and the invention is not limited thereto, except insofar as the claims are so limited. Those skilled in the art who have the disclosure before them will be able to make modifications and variations therein without departing from the scope of the invention.

1. A radial tire comprising:
a) a pair of sidewall portions disposed on each side of a midcircumferential plane of the tire, each having a bead area within the sidewall portion;
b) a plurality of beads disposed within each of the bead areas; and
c) a carcass, wherein the carcass further comprises a plurality of body plies wrapped around the beads.

2. The radial tire of claim 1, wherein the plurality of body plies are nylon.
